(19) United States
(12) Patent Application Publication
(10) Pub. No.: US 2018/0189657 A1
(43) Pub. Date: Jul. 5, 2018

(54) DEPLOYING LOCAL Q AND A SYSTEMS IN IoT DEVICES

(71) Applicant: International Business Machines Corporation, Armonk, NY (US)

(72) Inventor: Christopher K. Karstens, Miami Beach, FL (US)

(73) Assignee: International Business Machines Corporation, Armonk, NY (US)

(21) Appl. No.: 15/399,722

(22) Filed: Jan. 5, 2017

(51) Int. Cl. G06N 5/02

(52) U.S. Cl. CPC G06N 5/022

(57) ABSTRACT

Using a specification of a device, a performance capability of the device is computed for hosting a local question and answer (Q and A) system on the device. Based on the specification and a Q and A need, a knowledgebase is selected from a set of knowledgebases in use at a remote Q and A system. The knowledgebase is pruned according to the performance capability of the device, forming a pruned knowledgebase. A Q and A system container (container) is constructed using the pruned knowledgebase. A subset of algorithms is added in the container from a set of algorithms in use at the remote Q and A system. The algorithms in the subset apply to the pruned knowledgebase. The container is deployed as the local Q and A system on the device and updated using an evaluation of an operation of the container.

### TECHNICAL FIELD

The present invention relates generally to a method, system, and computer program product for providing question and answer capabilities in devices. More particularly, the present invention relates to a method, system, and computer program product for deploying local Q and A systems in Internet of Things (IoT) devices.

### BACKGROUND

The IoT is the network of physical objects embedded with electronics, sensors, software and connectivity to enable the exchange of data with other connected devices over a data communication infrastructure according to a standard or specification. It is contemplated within IoT that devices such as refrigerators, thermostats, lighting appliances, vending machines, access-control devices, peripherals, a variety of mobile devices—including smartphones and other mobile communication devices, and many other devices in everyday use (collectively referred to hereinafter as “device” or “IoT device”), will be able to communicate and interoperate with each other using such an infrastructure.

According to some estimates, the number of interconnected IoT devices is expected to reach 50 billion by the year 2020 with exponential growth thereafter. Each device in the IoT implements certain necessary components to interoperate on the specified IoT infrastructure.

A question and answer system (Q and A system) is an artificial intelligence application executing on a data processing hardware. IBM Watson is an example of Q and A system. (IBM and Watson are trademarks of International Business Machines Corporation in the United States and in other countries).

A Q and A system answers questions pertaining to a given subject-matter domain. The answers can be presented in natural language. Typically, a Q and A system has access to a collection of domain specific information based on which the Q and A system answers questions pertaining to that domain. For example, a Q and A system accesses a body of knowledge about the domain, where the body of knowledge (knowledgebase) can be organized in a variety of configurations. An example knowledgebase of a domain can include structured repository of domain-specific information, such as ontologies, or unstructured data related to the domain, or a collection of natural language documents about the domain.

In an example operation, a Q and A system receives an input question, parses the question to extract the major features of the question, uses the extracted features to formulate queries, and applies those queries to the corpus of data, e.g., the knowledgebase. Based on the application of the queries to the corpus of data, the Q and A system generates a set of hypotheses or candidate answers to the input question, by looking across the corpus of data for portions of the corpus of data that have some potential for containing a valuable response to the input question.

The Q and A system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the Q and A system. The statistical model may then be used to summarize a level of confidence that the Q and A system has regarding the evidence that the potential response, i.e. candidate answer, is inferred by the question. This process may be repeated for each of the candidate answers until the Q and A system identifies candidate answers that surface as being significantly stronger than others and thus, generates a final answer, or ranked set of answers, for the input question.

As can be seen from the above description, a Q and A system needs and expects significant computing power to operate. As can also be seen from the above description, an IoT device—even the present-day smartphones—are significantly limited in the computing power they possess, and are further limited in how much of that limited computing power they can spare for performing functions other than the functions for which they are primarily configured.

### SUMMARY

The illustrative embodiments provide a method, system, and computer program product. An embodiment includes a method that computes, at an application operating using a processor and a memory, using a specification of a device, a performance capability of the device for hosting a local question and answer (Q and A) system on the device. The embodiment selects, based on the specification and a Q and A need, a knowledgebase from a set of knowledgebases in use at a remote Q and A system. The embodiment prunes the knowledgebase according to the performance capability of the device, forming a pruned knowledgebase. The embodiment constructs a Q and A system container (container) using the pruned knowledgebase. The embodiment adds a subset of algorithms in the container from a set of algorithms in use at the remote Q and A system, wherein the algorithms in the subset apply to the pruned knowledgebase. The embodiment deploys the container as the local Q and A system on the device. The embodiment updates the container using an evaluation of an operation of the container.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for deploying local Q and A systems in IoT devices in accordance with an illustrative embodiment;

FIG. 4 depicts a block diagram of an example configuration of an application for deploying local Q and A systems in IoT devices in accordance with an illustrative embodiment; and

FIG. 5 depicts a flowchart of an example process for deploying local Q and A systems in IoT devices in accordance with an illustrative embodiment.

### DETAILED DESCRIPTION

Presently, a Q and A system can be configured to operate remotely, e.g., in a datacenter, and a device can be configured to utilize the remotely operating Q and A system. For example, a user can present a question via the device to the remote Q and A system, the device transmits the question to the remote Q and A system over a data network, the remote Q and A system performs the computation in the datacenter and transmits the answer back to the device over the data network, and the device presents the answer to the user.

The illustrative embodiments recognize that while using a remote Q and A system can work in this manner in some circumstances, many devices have to be able to operate and provide Q and A functionality autonomously. For example, a device may not be able to connect to a remote Q and A system but may have to answer a question regardless of the connectivity. As another example, as the number of devices grows, using a remote Q and A system to support the diverse Q and A needs of millions of devices can become cost-prohibitive and undesirable for other reasons.

The illustrative embodiments recognize that enabling a device with a local Q and A system is useful. Furthermore, the illustrative embodiments recognize that the enabling should be performed in such a manner that the local Q and A system on the device become progressively more independent of the remote Q and A system with the passage of time and usage of the local Q and A system. However, given the wide variety of devices, the varying degrees of capabilities of this variety of devices, the various purposes and needs that the devices are configured to address, and the limited computing resources available at the devices, the configuration of the local Q and A system on the devices is a non-trivial task.

For example, a local Q and A system configured on a smartphone should be able to answer questions about a wider range of subjects, provide more accurate answers, and provide those answers faster, as compared to a local Q and A system embedded in, say, an IoT-enabled refrigerator. As an example, the smartphone-based local Q and A system should be able to answer questions ranging from game strategy for a variety of games to medical diagnosis to financial consultation, whereas a refrigerator would be expected to be able to answer questions about groceries and food habits.

Similarly, a local Q and A system configured in a robot should be able to understand and repair any type of machine placed before it by performing Q and A about the machine. A machine related to farming operation, or a smartphone, should be able to answer crop planting related questions.

These and many other similar Q and A operations should be possible locally at a variety of devices. Furthermore, such operations should be possible with no help from, or progressively decreasing amount of reliance on a powerful remote Q and A system. Furthermore, with the passage of time, and with ongoing usage, a local Q and A system should become better at answering questions, e.g., by improving an accuracy of an answer, a speed at which the answer is computed, a diversity of subject-matter that is handled, a depth of knowledge that is used in answering questions, or some combination of these and other considerations.

The illustrative embodiments recognize that the presently available tools or solutions do not address these needs or provide adequate solutions for these needs. The illustrative embodiments used to describe the invention generally address and solve the above-described problems and other problems related to deploying local Q and A systems in IoT devices.

An embodiment can be implemented as a software application. The application implementing an embodiment can be configured as a modification of an existing remote Q and A system, as a separate application that operates in conjunction with an existing remote Q and A system, a standalone application, or some combination thereof.

Some examples of the capabilities that will become possible with the use of an illustrative embodiment are described now—

Assume that a user wants to play the game of checkers using a device. This is a circumstance that is different from installing a Checkers game app on the user's device and playing the game in that app. Under the circumstances contemplated, the user has decided that the user wants the device to play against the user in a game of checkers (or for that matter, participate in an activity of the user's choice for which an app may not be available).

A well-known Q and A system, i.e., IBM Watson, can be regarded as knowing everything about everything. Accordingly, it can be safely assumed that Watson knows the rules, strategies, etc. behind the game of checkers. The user wants Watson's knowledge regarding checkers to enable the user's device to play against the user. Watson has 213,481 Gigabytes (GB) of knowledge about checkers. Given the device's limited resources, and the desire that the device's other functions not be significantly affected by the device's participation in the selected activity. Just like a human can be coached to get better at the game of checkers, the user would expect the device's skill and participation to improve with the passage of time and ongoing participation, particularly if the activity is something in which the user routinely engages.

A presently available domestic service robot is another example where “knowing everything about everything” is not needed. The robot incorporates the body, the sensors, and the balance to navigate the real world. What the robot lacks is the knowledge, e.g., the knowledge about how to repair the motor in front of it, or how to play a board game a human puts in front of it. Again, Watson has the knowledge. The robot may be configured to perform a given task where a broadband connection to a remote instance of Watson in a datacenter exists. But absent such a connection, the robot is not equipped with the knowledge of autonomously recognizing a problem and solving it. With the assistance of an illustrative embodiment, the robot can be coached to perform a very specific task, e.g., repair a specific motor or play a specific board game.

Generally, a user's needs or expectations from a device are not limited to trivia such as playing checkers, but in more sophisticated knowledge-based abilities of a remote Watson-like system that are useful in making good business decisions under various circumstances. For example, an insurance agent in the field with a tablet and no internet connection can be enabled by an illustrative embodiment to quote (or not quote) a policy. As an example, a remote instance of a Q and A system in a datacenter may have 1000 GB of insurance-related knowledge pertaining to the highest hitting data for the agents territory of hundreds of square miles, e.g., the history of the buildings, the history of the locations, the history of the environments (air/water quality), the history of insurance quotes, the history of all claims, all comparable quotes in the area, construction materials used in similar properties, best materials for a particular environment, current spot prices for materials used, what to do when various conditions are discovered on the site, and so on.

This knowledge, when used with a Q and A system is helpful to the agent in making a sound business decision. An illustrative embodiment enables a device of the agent to answer these types of questions locally—i.e., at the device without reliance on a remote Q and A system. Furthermore, the illustrative embodiments can locally review the agent's performance, compare the performance to the company targets and different company agents' achievements, then modify, add, or delete knowledge based on the performance and usage specific to that device and specific to that user.

One of the challenges in enabling local devices with Q and A capabilities is the ability to add or modify existing knowledge at the device and improve an answer over time. For example, a user might be interested in using the user's device to know “how to plant corn.” An initial answer might be not much more than a guess, but a process of an illustrative embodiment can improve the answer for the user over time and experience by knowing that the question really is “what is the best time to plant yellow corn in zip code 90210 with novice farming skills?” an embodiment is able to impart the device the knowledge related to the type of corn, the USA zip code where the corn will be planted (weather, temperature, rainfall, etc.) and an estimate of the farmer's skills, to provide a more accurate answer not only to the question about planting corn but other farming related questions as well.

Many devices of varying capabilities are expected to proliferate the world. Data connectivity to remote systems may be sporadic at best for many of these devices. Using the illustrative embodiments, it is possible to enable inexpensive devices of very limited capabilities deployed in remote parts of the world with knowledge about how to treat region-specific illnesses. Using the illustrative embodiments, it is possible to place a robot in a farm, impart farming knowledge to the robot, and teach it farming skills.

Such devices enabled by the illustrative embodiments may or may not arrive at the best answer or arrive at the answer in the shortest possible time, but they will arrive at a needed answer, using the knowledge about the subject-matter in question, and become better at solving problems in that subject-matter domain. For example, perhaps a cell phone takes 5 minutes, 15 minutes, or even 45 minutes to arrive at an answer that the Watson supercomputer can deliver in less than one second. The big leap forward made possible by the illustrative embodiments is the answer itself. The tailored knowledge sharing and improvement regardless of network availability also significantly reducing the volume of duplicative and repetitive knowledge requests to remote Q and A systems.

Now, the illustrative embodiments are described with respect to the novel operations, functions, and combinations thereof, as follows—

A “remote Q and A system” or a “remote system” as used herein refers to an instance of a Q and A system operating using one or more data processing systems and accessible over a data network. A “local Q and A system,” a “local system,” a “local container,” a “Q and A system container,” or a “container” refers to an instance of a Q and A system installed on a device as described herein.

An embodiment analyzes the specifications of a device on which a container is to be deployed. A remote system is assumed to have access to the specification information of a variety of devices, from which the embodiment selects the specification of the device in question. The analysis of the device specification allows the embodiment to compute the amount and types of computing resources available at the device for use by a container.

An embodiment additionally queries a user associated with device about the needs that have to be satisfied by the container. As a non-limiting example, the embodiment analyzes from a set of user inputs the subject-matter domain whose knowledge has to be used at the container for answering questions or performing tasks expected by the user. The embodiment can extract additional insights from the needs analysis, e.g., the complexity level of questions to expect, the accuracy of answers the user expects, the amount of time the user can permit or accept for computing an answer, restrictions on accessing a data network from the device, and the like.

Using the results of the device specification analysis and the user needs analysis, an embodiment constructs a container. The container is suitable for operation on that specific device or type of device, and satisfies the needs specified in or extracted from user inputs.

For example, the embodiment selects a specific subject-matter domain according to the needs analysis. The embodiment selects a knowledgebase (KNOWLEDGEBASE) from a collection of knowledgebases available at the remote system. The selected knowledgebase pertains to the selected subject-matter domain. Furthermore, the embodiment selects a span or depth of the knowledgebase according to the specification analysis, needs analysis, or both. For example, a beginner farmer may not need the knowledge about the nuances of treating a crop disease that is rare for the contemplated region or crop. As another example, a novice checkers player may not need the knowledge about advanced game strategies, and a robot trying to repair a direct current (DC) motor may not need the knowledge about alternating current (AC) motors or generators.

Additionally, as described herein, a Q and A system uses numerous algorithms to compute an answer and the confidence value of the answer. Various algorithms consume varying amounts of computing resources and provide varying degrees of accuracy, confidence or reliability, computational efficiency or performance, or a combination thereof. Accordingly, in constructing the container, an embodiment further selects a subset of a set of algorithms from the remote system. The subset of algorithms includes only those algorithms that are configured to deliver the expected accuracy, confidence, computational efficiency, or a combination thereof.

Some algorithms can be knowledgebase-specific. Accordingly, the subset of algorithms can also include (or exclude) some algorithms that are configured to operate on the selected knowledgebase.

Generally, the embodiment uses the specification analysis and the needs analysis to trim or prune the selected knowledgebase, the set of algorithms, or both, such that the target device can accommodate the container size, and the container can answer the expected level of questions in the one or more expected subject-matter domains. The embodiment deploys the container on the device.

In operation, the container performs computations locally on the device to provide answers to the questions. Occasionally, the container may not be able to provide an answer at all, provide a sufficiently accurate answer, provide an answer with sufficient confidence value, provide an answer in a permitted amount of time, provide an answer that requires knowledge not configured in the container, or some combination thereof. To handle such circumstances, an embodiment configures the container to be able to communicate with a remote system over a data network. Thus, while the container attempts to maximize the local computations of answers, the container can reach out to a remote system under certain circumstances.

An embodiment observes or monitors the operation of a container. The embodiment collects observation data from the container, which includes, but is not limited to performance metrics of the container, knowledgebase usage metrics, number and types of requests sent to remote system, questions presented to the container, answers provided from the container, and many others. Some examples of a performance metric may be the longest/shortest/average amount of time taken to produce an answer over a period, the most/least/average amount of a computing resource consumed to produce an answer, and the like. Some examples of knowledgebase usage metrics include the branch of knowledgebase hierarchy most/average/least traversed, number of questions that could/could not be answered based on the available knowledgebase, and the like.

Using the observation data, an embodiment evaluates the container. For example, in one manner of an automatic comparative evaluation (auto-comparative evaluation) for a question that was presented to the container, one embodiment executes the question in the remote system and compares the answer provided by the remote system and the answer provided by the container. The comparison can be of the completeness, accuracy, confidence value, or precision of the answers, or some combination thereof.

In another manner of auto-comparative evaluation, for a question that was presented to the container, one embodiment executes the question in another container. The other container may be of the same configuration, similar configuration, or a different configuration. The embodiment compares the answer provided by the other container and the answer provided by the container. Again, the comparison can be of the completeness, accuracy, confidence value, or precision of the answers, or some combination thereof.

An embodiment can also perform a survey-like evaluation. In a survey-like evaluation, the embodiment asks the user questions about the performance, accuracy, timeliness, completeness, correctness, and other aspects of the answers provided by the container. A survey-like evaluation produces the same or similar data as the auto-comparative evaluations.

The evaluations performed by an embodiment can be subject-matter domain specific. For example, a checkers game takes a few minutes to complete but a corn crop may take months to complete. These evaluations determine how the knowledge an embodiment provided in the container actually performed. For example, an embodiment may evaluate a container at every move of last 100 checkers games to better understand the end user/device. The result of the evaluation is used by an embodiment to modify, update, change, or otherwise adjust the knowledgebase, the algorithms, or both of a container to improve some aspect of the observation data.

For example, it may turn out that the user playing checkers against the container is a defensive player according to last 100 moves or games, and a different algorithm might provide a better user experience than the algorithm currently in use. Perhaps a more advanced strategy can also be added to the knowledgebase and obsolete or erroneous data can be removed from the knowledgebase as well, knowledge that has never been accessed by the user can be removed and replaced with something more likely to help.

The evaluations can be scheduled at regular intervals, varying intervals, from time-to-time, based on certain events, or some combination thereof. For example, an evaluation may be computed after every 20 games, after first 20 games then after next 50 games then after next 100 games and no more thereafter, when two requests are sent to remote system, when an answer fails to compute in the given amount of time, and so on.

Some observation data can be used to train the remote system as well. Given that millions of containers covering a wide variety of subject-matter domains can be deployed at any given time, it is likely that at least some containers will be used in unpredictable manners, be asked questions not thought of before, be presented with scenarios not seen before, and the like. The observation data collected about such occurrences provides opportunities for improving the capabilities and training of the remote system. The improved training can result in improved knowledgebases, improved algorithms, or both. The improvements can then be pushed out to the containers when the containers are updated as described herein.

An embodiment updates an already deployed container. An update can be triggered by an observed data indicative of a problem or unacceptable condition at the container, by an evaluation result, by the availability of a new/better/different algorithm or knowledgebase data at the remote system, or some combination thereof. An update can include addition, modification, or removal of a knowledgebase or a portion thereof, an algorithm, or both. Some example objectives satisfied by an update include, but are not limited to, improving an answering capability of the container according to an evaluation, improving an answering capability of the container according to a retaining of the remote system, improving a metric in the observation data, reducing a number of requests sent to the remote system, performing a maintenance on the container, or some combination of these and other objectives.

The manner of deploying local Q and A systems in IoT devices described herein is unavailable in the presently available methods. A method of an embodiment described herein, when implemented to execute on a device or data processing system, comprises substantial advancement of the functionality of that device or data processing system in providing localized Q and A capabilities in a coaching-type model where the dependency of the local Q and A system on a larger remote Q and A system is weaned over time while improving the answering capabilities of the local system.

The illustrative embodiments are described with respect to certain types of specifications, needs, knowledgebases, Q and A systems, operations, questions, answers, observations, observed data, evaluations, updates, training, deployments, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

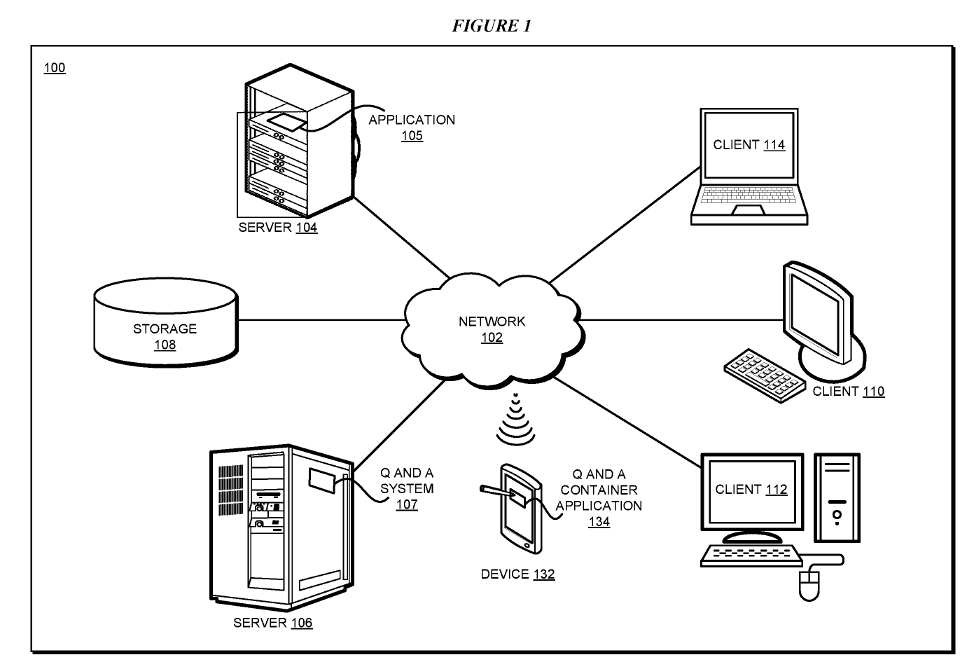

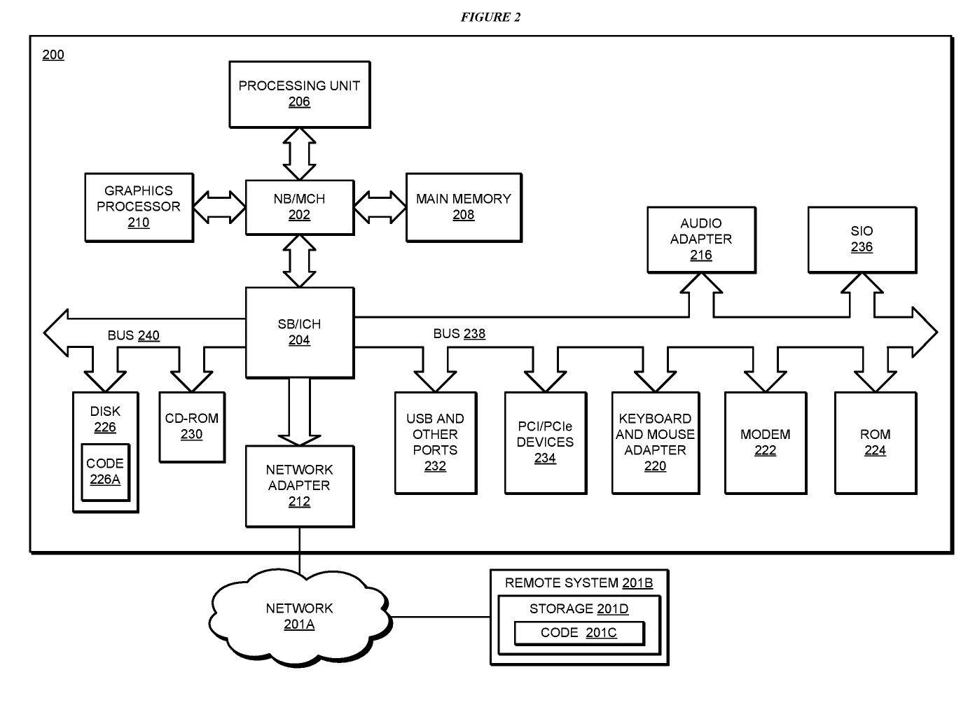

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Application 105 operates in conjunction with Q and A system 107, which is an example of a remote Q and A system as described herein. Application 105 deploys container Q and A system 134 in device 132. Device 132 is an example of an IoT device as described herein. Container Q and A system 134 is an example of a container as described herein. Application 105 constructs, deploys, observes, evaluates, and updates container 134 as described herein.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCl/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCl/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro- SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

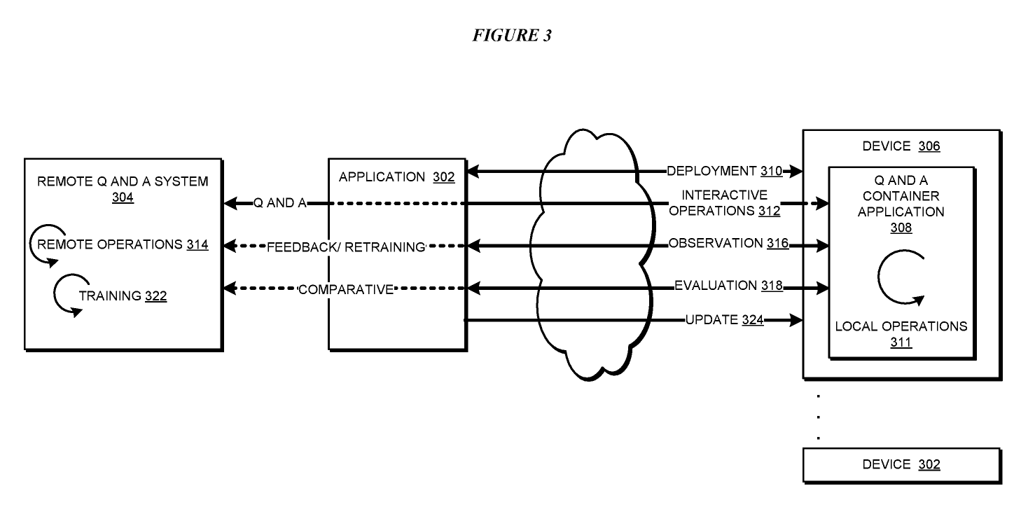

With reference to FIG. 3, this figure depicts a block diagram of an example configuration for deploying local Q and A systems in IoT devices in accordance with an illustrative embodiment. Application 302 is an example of application 105 in FIG. 1. Remote Q and A system 304 is an example of Q and A system 107 in FIG. 1. Device 306 is an example of device 132 in FIG. 1.

Application 302 analyzes a specification of device 306, a Q and A need of a user associated with device 306, or both, as described herein. Based on the result of the analyses, application 302 constructs container 308 using the set of knowledgebases and algorithms available at remote system 304. Application 302 performs deployment step 310 to deploy, deliver, configure, or otherwise make available for use, container 308 at device 306.

In operation, container 308 answers questions through local computations 311 on device 306. Occasionally, as described herein, container 308 may have to seek the assistance of remote system 304. In such cases, container 308 performs interactive operations 312 with remote system 304 by sending all or part of a question to remote system 304. Remote system 304 performs remote operations 314 to compute and return an answer.

Application 302 performs observation 316 of container 308, as described herein. Application 302 collects observation data through observations 316.

Application 302 performs evaluation 318 of container 308′s operations. For example, application 302 may perform auto-comparative remote operation 314 on remote system 304, or an auto-comparative operation (not shown) on a container (not shown) in device 320. During evaluation 318, application 302 may also send survey-like questions to the user of device 306, as described herein.

Using the observed data, application 302 causes retraining 322 of remote system 304. Retraining 322, evaluation 318, or some combination thereof, may result in an update for container 308. Application 302 constructs an update for container 308 and sends to device 306 via update step 324, as described herein. Update operation 324 causes an improvement in at least some of the observation data in a manner described herein.

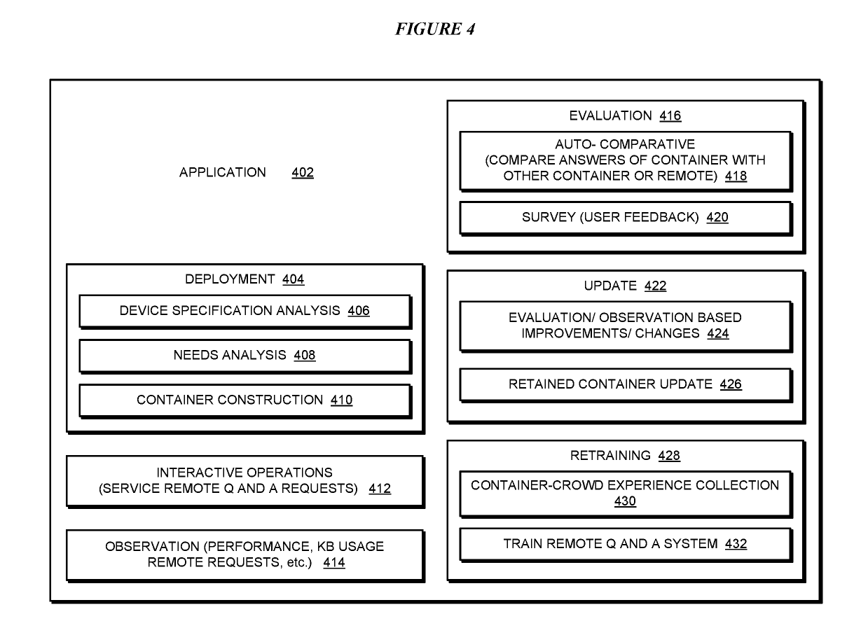

With reference to FIG. 4, this figure depicts a block diagram of an example configuration of an application for deploying local Q and A systems in IoT devices in accordance with an illustrative embodiment. Application 402 is an example of application 302 in FIG. 3.

Component 404 deploys a container at a device. Subcomponent 406 analyzes the specification of the device. Subcomponent 408 analyzes the Q and A needs of the user of the device. Subcomponent 410 constructs the container for deployment.

Component 412 facilitates interactive operations in the manner of interactive operations 312 in FIG. 3. Component 414 performs observations 316 in FIG. 3.

Component 416 evaluates the operations of a container, e.g., in the manner of evaluation 318 in FIG. 3. Subcomponent 418 performs auto-comparative evaluation with a remote Q and A system, one or more other containers, or a combination thereof, as described herein. Subcomponent 420 performs a survey-like evaluation as described herein.

Component 422 updates a container. Subcomponent 424 computes those changes for the update that are based on some observed data of the container, an evaluation of the container's operation, or both. Subcomponent 426 computes those changes that are resultant from a retraining or modification of a remote system on which the container is based.

Component 428 performs or enables the performance of a retraining operation on a remote system. Subcomponent 430 crowd-sources container experiences from the numerous containers deployed at any given time. In other words, as described herein, different containers will experience different circumstances and questions, which are beneficial in improving a knowledgebase or an answer production of a remote system. Subcomponent 430 facilitates this type of retraining. Subcomponent 432 facilitates other types of training, adjustments, modifications, or retraining of the remote system.

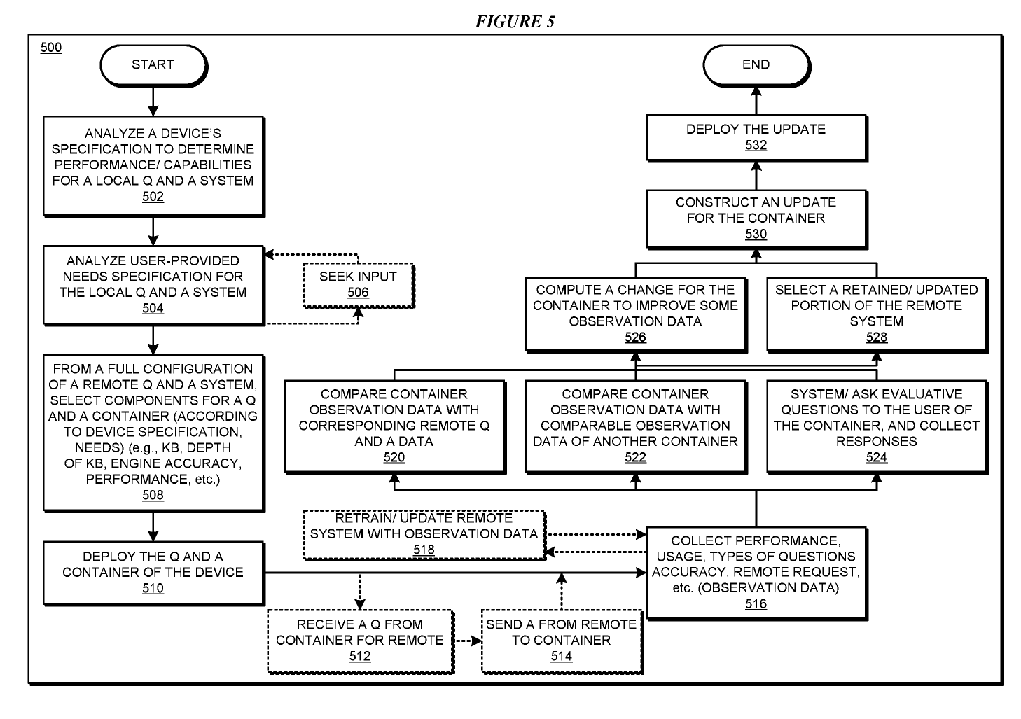

With reference to FIG. 5, this figure depicts a flowchart of an example process for deploying local Q and A systems in IoT devices in accordance with an illustrative embodiment. Process 500 can be implemented in application 402 in FIG. 4.

The application a device's specification to determine the performance and capabilities of the device for hosting a local Q and A system (block 502). The application analyses user-provided needs specification for the local Q and A system (block 504). The application may, optionally, actively seek user input to collect the needs-specification of block 504 (block 506).

From a full configuration of a remote Q and A system, the application selects components—e.g., all or parts of some or all knowledgebases, all or some algorithms, or some combination thereof, for constructing a container according to the analysis results from blocks 502 and 504 (block 508). The application deploys the container on the device (block 510).

During the operation of the container on the device, the application may, optionally, receive a question from the container for computation on the remote system (block 512). The application causes the remote system to compute the answer and facilitates sending the answer to the container (block 514).

The application collects observation data from the container (block 516). Optionally, the application causes a retraining of the remote system using the observation data (block 518).

The application can perform an evaluation of the container using one or more of the following three possible evaluation process paths—(i) the application compares the an answer, some or all observation data, or some combination thereof, of the container with corresponding information generated or obtained from the remote system (block 520); (ii) the application compares the an answer, some or all observation data, or some combination thereof, of the container with corresponding information generated or obtained from one or more other containers (block 522); and (iii) the application surveys, or asks questions, to a user of the container about an answer, a performance, or both, of the container, and collects the user's responses (block 524).

Using the data obtained from blocks 520, 522, and/or 524, the application computes a change for the container such that the change improves at least some of the observation data of the container (block 526). The application may also, optionally, select a retrained or updated portion of the remote system as an update for the container (block 528).

The application constructs an update for the container using the changes and portions selected at blocks 526 and/or 528 (block 530). The application deploys the update to the container (block 532). The application ends process 500 thereafter.

Thus, a computer implemented method, system or apparatus, and computer program product are provided in the illustrative embodiments for deploying local Q and A systems in IoT devices and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
computing, at an application operating using a processor and a memory, using a specification of a device, a performance capability of the device for hosting a local question and answer (Q and A) system on the device;
selecting, based on the specification and a Q and A need, a knowledgebase from a set of knowledgebases in use at a remote Q and A system;
pruning the knowledgebase according to the performance capability of the device, forming a pruned knowledgebase;
constructing a Q and A system container (container) using the pruned knowledgebase;
adding a subset of algorithms in the container from a set of algorithms in use at the remote Q and A system, wherein the algorithms in the subset apply to the pruned knowledgebase;
deploying the container as the local Q and A system on the device; and
updating the container using an evaluation of an operation of the container.

2. The method of claim 1, further comprising:
enabling the container to present a question to the remote Q and A system, wherein a computation of an answer to the question at the container exceeds the performance capability of the device; and
enabling the container to obtain the answer from the remote Q and A system.

3. The method of claim 2, wherein the performance capability comprises a maximum computation time for the answer.

4. The method of claim 1, further comprising:
collecting a set of observation data from the container, the set of observation data comprising a set of answers computed by the container in response to a specified number of questions presented to the container during a past period, wherein the evaluation of the operation of the container evaluates the set of answers; and
constructing an update for the container, the update improving at least one answer in the set of answers.

5. The method of claim 4, wherein the improving at least the one answer increases an accuracy of the at least one answer.

6. The method of claim 4, wherein the improving at least the one answer decreases an amount of time needed to compute the at least one answer.

7. The method of claim 4, wherein the container obtained the at least one answer from the remote Q and A system, and wherein the improving at least the one answer causes a computation of the at least one answer locally at the container.

8. The method of claim 4, further comprising:
computing, as a part of an auto-comparative evaluation, at the remote Q and A system, a remote answer corresponding to a selected question in the specified number of questions;
computing a difference between the remote answer and an answer in the set of answers that corresponds to the selected question; and
selecting a component for the update, the component causing the container to produce a second answer, the second answer having a smaller difference from the remote answer as compared to the difference.

9. The method of claim 8, wherein the component is a new algorithm.

10. The method of claim 8, wherein the component is a new portion of the selected knowledgebase.

11. The method of claim 4, further comprising:
computing, as a part of an auto-comparative evaluation, at a second container operating in a second device, a comparative answer corresponding to a selected question in the specified number of questions;
computing a difference between the comparative answer and an answer in the set of answers that corresponds to the selected question; and
selecting a component for the update, the component causing the container to produce a second answer, the second answer having a smaller difference from the comparative answer as compared to the difference.

12. The method of claim 4, further comprising:
retraining the remote Q and A system using the set of observation data;
selecting a retrained component from the retrained remote Q and A system; and
including, in the updating, the retrained component.

13. The method of claim 1, further comprising:
selecting each algorithm in the subset such that a performance metric of each algorithm is within the performance capability of the device.

14. The method of claim 1, wherein the knowledgebase applies to a subject-matter domain identified in the Q and A need.

15. The method of claim 1, further comprising:
computing, from a set of user inputs at the device, a needs specification, wherein the needs specification identifies the Q and A need of the user.

16. The method of claim 1, wherein the application operates in the remote Q and A system.

17. A computer usable program product comprising one or more computer-readable storage devices, and program instructions stored on at least one of the one or more storage devices, the stored program instructions comprising:
program instructions to compute, at an application operating using a processor and a memory, using a specification of a device, a performance capability of the device for hosting a local question and answer (Q and A) system on the device;
program instructions to select, based on the specification and a Q and A need, a knowledgebase from a set of knowledgebases in use at a remote Q and A system;
program instructions to prune the knowledgebase according to the performance capability of the device, forming a pruned knowledgebase;
program instructions to construct a Q and A system container (container) using the pruned knowledgebase;
program instructions to add a subset of algorithms in the container from a set of algorithms in use at the remote Q and A system, wherein the algorithms in the subset apply to the pruned knowledgebase;
program instructions to deploy the container as the local Q and A system on the device; and
program instructions to update the container using an evaluation of an operation of the container.

18. The computer usable program product of claim 17, wherein the computer usable code is stored in a computer readable storage device in a data processing system, and wherein the computer usable code is transferred over a network from a remote data processing system.

19. The computer usable program product of claim 17, wherein the computer usable code is stored in a computer readable storage device in a server data processing system, and wherein the computer usable code is downloaded over a network to a remote data processing system for use in a computer readable storage device associated with the remote data processing system.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to compute, at an application operating using a processor and a memory, using a specification of a device, a performance capability of the device for hosting a local question and answer (Q and A) system on the device;
program instructions to select, based on the specification and a Q and A need, a knowledgebase from a set of knowledgebases in use at a remote Q and A system;
program instructions to prune the knowledgebase according to the performance capability of the device, forming a pruned knowledgebase;
program instructions to construct a Q and A system container (container) using the pruned knowledgebase;
program instructions to add a subset of algorithms in the container from a set of algorithms in use at the remote Q and A system, wherein the algorithms in the subset apply to the pruned knowledgebase;
program instructions to deploy the container as the local Q and A system on the device; and
program instructions to update the container using an evaluation of an operation of the container.
